(19) United States
(12) Patent Application Publication
(10) Pub. No.: US 2012/0062392 A1
(43) Pub. Date: Mar. 15, 2012

(54) System and Method for Protecting Assets from Harm and for Reducing Insurance Risk

(76) Inventors: David P. Ferrick, Lexington, MA (US); Tod Farrell, Coppell, TX (US); Gary Wallace, Euless, TX (US)

(21) Appl. No.: 13/231,032

(22) Filed: Sep. 13, 2011

Related U.S. Application Data
(60) Provisional application No. 61/382,560, filed on Sep. 14, 2010.

(51) Int. Cl. G08G 1/0967

(52) U.S. Cl. 340/905

(57) ABSTRACT

A method for warning at least one contact person associated with a vehicle that the vehicle is within a geographical warning zone includes initiating and establishing a wireless communication link between a vehicle telematics system of the vehicle and a control system remote from the vehicle. The control system includes a weather identification system, a map database, and a data processing system operable to communicate with the weather identification system and the map database though a communication link. A dangerous weather condition is detected and a geographic area within which the dangerous weather condition is identified. The geographic area is communicated to the data processing system. The geographic area interfaces with the map database to define a geographic warning zone. The vehicle is located within the geographic warning zone and a warning message is communicated to the person associated with the vehicle regarding the vehicle being in the warning zone.

### CROSS-REFERENCE TO RELATED APPLICATIONS

This application claims priority, under 35 U.S.C. §119, to U.S. Provisional Patent Application Ser. No. 61/382,560, filed on Sep. 14, 2010, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention relates generally to protecting physical assets, such as vehicles, from natural disasters and, in doing so, proactively reducing and managing insurance risk for such assets. More particularly, the present invention relates to a system and method for warning owners of impending danger and routing exposed assets to safety. A corollary to such a system and method permits insurance carriers to lower risk of asset damage, which, in turn, results in cost savings to insureds.

### BACKGROUND OF THE INVENTION

Owners of any kind of vehicle, including cars, trucks, motorcycles, boats, and planes, to name a few, are generally solely responsible for the protection of such vehicles. While insurance carriers typically cover some expenses associated with damage that occurs to the vehicle, for example, flood damage, the owner is, nevertheless, responsible for deductable amounts and must undergo the hassle of getting the vehicle repaired and facing the realization that the vehicle may not be able to be repaired to its original condition.

If the owner wants to prevent harm to the vehicle, the only available method is to physically guard that asset, for example, by keeping it in an enclosure, such as a garage. Keeping a vehicle covered at all times is, generally, impractical. This is particularly true when, for instance, the owner uses the vehicle to commute back and forth to work and no covered parking is available at the work place.

One other way to protect a vehicle is to move it from harm's way. While alarms exist to deter theft and injury and to inform owners that the security of the vehicle has been breached in some way, there exists no automatic system that anticipates an impending weather danger and informs the owner in a timely manner that harm is about to or likely to occur so that the owner can take preventative action to protect that vehicle from the impending danger. It is true that news coverage gives owners anticipated times of arrival of storms, including hurricanes and some tornados, but neither the Internet, television, nor radio provide information targeted to specific owners. In addition, most people are only able to watch television, listen to the radio, or read stories on the Internet at discrete, limited times during the day. This typically only includes breakfast and dinnertime for most people. There is, therefore, a large block of time each day when the average person is ignorant of impending weather conditions.

Audible lightning and tornado alarms exist and provide instant notice of impending danger. However, those devices and systems are omnidirectional and only suggest that harm might occur in the particular surrounding area. Such alarms do not provide any particular owner with information that directs the owner to safety. Moreover, these alarms are only used for the most extreme weather situations, e.g., tornados and lightning. They are not wide enough to cover non-tornado force winds or hail storms within a lightning storm. In addition, modern window technology, e.g., insulated, double pane, hurricane glass, etc., greatly attenuates the penetration of alarm sounds into buildings, making it likely that the audible-only alarm is not even noticed.

With only the current systems and/or methods for learning of impending storms or otherwise bad weather, one responsible for a vehicle is left with the choice of either constantly monitoring weather information channels, such as television, radio, or the Internet, or ensuring that their vehicle is covered at all times. This, however, is simply impractical for most people.

In addition, insurance carriers are left with standard actuarial processes to guess when and how weather-related injury will occur to insured assets, and that assessment is averaged out over an entirety of the set (or sub-set) of the carriers' customers. As a result, some persons will pay inflated premiums. Insurance carriers have no ability to actively avoid risk to a particular insured asset or to communicate in advance to a particular insured that the insured asset needs to be moved presently or harm will occur.

Thus, a need exists to overcome the problems with the prior art systems, designs, and processes as discussed above.

### SUMMARY OF THE INVENTION

The present invention provides a system and method for protecting assets from harm and for reducing insurance risk that overcome the hereinafore-mentioned disadvantages of the heretofore-known devices and methods of this general type and that automatically anticipates an impending danger and informs the owner in a timely manner that harm is about to or likely to occur so that the owner can take preventative action to protect that vehicle from the impending danger. Particular owners are provided with detailed information that harm is imminent and also can direct the owner to a place of safety for storing the asset until the harm abates.

With the foregoing and other objects in view, there is provided, in accordance with the invention, a method for warning at least one pre-assigned contact person associated with a vehicle that the vehicle is within a geographical warning zone. The method comprises the steps of initiating and establishing a wireless communication link between a vehicle telematics system of the vehicle and a control system remote from the vehicle, the control system including a weather identification system, a map database, and a data processing system operable to communicate with the weather identification system and the map database though at least one communication link, detecting a dangerous weather condition, identifying a geographic area within which the dangerous weather condition is detected, communicating the geographic area to the data processing system, interfacing the geographic area with the map database to define a geographic warning zone, locating the vehicle within the geographic warning zone, and communicating a warning message to the at least one pre-assigned contact person associated with the vehicle regarding the vehicle being located within the geographic warning zone.

In accordance with another mode of the invention, the data processing system includes telematics equipment operable to provide the vehicle telematics system with telematics services and a data center including at least one database server and at least one protocol gateway operable to exchange data with the at least one database server.

In accordance with a further mode of the invention, the data center is at least one of remote from the telematics equipment and communicatively connected thereto through a wireless communication link and co-located with the telematics equipment and communicatively connected thereto.

In accordance with an added mode of the invention, the located vehicle is a subscriber vehicle associated with a subscription plan provided by a telematics service provider.

In accordance with an additional mode of the invention, the locating step is carried out by receiving location information from the vehicle telematics system of the vehicle and comparing the received location information with the geographic warning zone to determine a subset of vehicles located within the geographic warning zone.

In accordance with yet another mode of the invention, for the at least one pre-assigned contact person associated with the vehicle, gathering contact information including at least one of a telephone number, an email address, and a pager number.

In accordance with yet a further mode of the invention, the step of communicating a warning message is carried out utilizing the gathered contact information.

In accordance with yet an added mode of the invention, the step of communicating the warning message is carried out by providing at least one of an audible message and a video display message through the vehicle telematics system, calling a telephone including at least one of a landline telephone and a mobile device, sending a text message, paging a device, and sending an email.

In accordance with yet an additional mode of the invention, there is provided at least one of the steps of receiving a responsive communication from the at least one pre-assigned contact person regarding receipt of the warning message and recording the communication attempt as successful and receiving no responsive communication from the at least one pre-assigned contact person and recording the communication attempt as unsuccessful.

In accordance with again another mode of the invention, if the communication attempt is successful and if the at least one pre-assigned contact person is located inside the located vehicle, direction information of a safe location is provided to the at least one pre-assigned contact person. The safe location is at least one of a pre-defined safe location within the geographic warning zone and a location outside the geographic warning zone.

In accordance with again a further mode of the invention, the at least one communication link is at least one of a direct communication link and a wireless communication link.

With the objects of the invention in view, there is also provided a system for warning at least one pre-assigned contact person associated with a vehicle that the vehicle is within a geographical warning zone The system comprises a control system remote from the vehicle and communicatively connected to a vehicle telematics system of the vehicle, the control system including a data processing system, a weather identification system operable to detect a dangerous weather condition, identify a geographic area within which the dangerous weather condition is detected, and communicate the geographic area to the data processing system, and a map database. The data processing system is operable to receive and process data from the vehicle telematics system and communicate with the weather identification system and the map database though at least one communication link. The control system is further operable to interface with the map database to define a geographic warning zone based upon the geographic area communicated from the weather identification system, locate a vehicle within the geographic warning zone, and communicate a warning message to the at least one pre-assigned contact person associated with the vehicle regarding the vehicle being located within the geographic warning zone.

In accordance with again an added feature of the invention, the data processing system includes telematics equipment operable to provide the vehicle telematics system with telematics services and a data center including at least one database server and at least one protocol gateway operable to exchange data with the at least one database server.

In accordance with again an additional feature of the invention, the at least one database server is operable to store information associated with the subscriber vehicle, the information including contact information for the at least one pre-assigned contact person associated with the subscriber vehicle including at least one of a telephone number, a email address, and a pager number.

In accordance with still another feature of the invention, the control system is operable to communicate the warning message to the at least one pre-assigned contact person through at least one of the vehicle telematics system including at least one of a visible display message and an audible message, a telephone call to at least one of a landline telephone and a mobile device, a text message, a page to a device, and an email.

In accordance with still a further feature of the invention, the control system is further operable to send information to the at least one pre-assigned contact person indicating a safe location.

In accordance with a concomitant feature of the invention, the vehicle telematics system interfaces with the telematics service provider through a wireless communication link established with at least one wireless network base station.

Although the invention is illustrated and described herein as embodied in a system and method for protecting assets from harm and for reducing insurance risk, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of an exemplary embodiment of a vehicle telematics communications infrastructure utilized with systems and methods of the present invention;

FIG. 2 is a block diagram of an exemplary embodiment of a control system in accordance with the present invention;

FIG. 3 is a fragmentary picture generated by weather radar indicating dangerous storm conditions in a geographic location;

FIG. 4 is a fragmentary portion of a road map including the geographic location of FIG. 3 with a portion of the map including the dangerous storm conditions encircled according to the present invention; and

FIG. 5 is a fragmentary portion of the road map of FIG. 4 defining a warning area according to the present invention corresponding to the encircled portion of the map in FIGS. 3 and 4.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The advent of telematics services, which were introduced over a decade ago, brought with it a trend to incorporate the ability of a vehicle to communicate with remote control centers and transmit location data and vehicle information related to safety, security, and emergency breakdown. “Telematics,” as it is referred to in the art, includes the integration of wireless communications, vehicle monitoring systems, and location devices. Such technologies in automotive communications combine wireless voice and data capability for management of information and safety applications. “Telematics,” as used herein, refers to any integrated use of telecommunications and “informatics,” which is the study, design, development, implementation, support or management of computer-based information systems, particularly software applications and computer hardware. Remote control centers” or “remote control systems” as used herein, refer to off-board systems in communication with the vehicle, the components of which can be, but are not necessarily, located at a central or same location. Alternatively, the components of the remote control centers may be located at various separate locations and connected through wireless communication links. Through telematics, the present invention allows the sending, receiving, and storing of information through telecommunication devices between the vehicular systems and remote control systems. The telematics of the present invention includes, but is not limited to, Global Positioning System (GPS) technology integrated with computers and mobile communications technology in automotive navigation systems.

Most of the early telematics communication was achieved through wireless voice channels that were analog in nature. By law in 2028, telecommunications carriers were no longer required to support analog connectivity and, as a result, the industry moved to digital connectivity and, consequently, data connectivity, such as “3G” technology, became a readily available measure for mobile devices to “connect” to the Internet. As a result of these advances, the vehicle is also being adapted to leverage data connectivity in combination with voice channel connectivity in what is referred to as the “connected car” concept.

The “connected car” concept has continued to evolve over the past few years and commercial launches of rather sophisticated vehicle services are becoming a reality. These services often rely on vehicle location and “on cloud computing,” defined as web services accessed over a data channel. Examples of these services include off-board routing, destination capture, remote-vehicle diagnostics, music downloads, traffic reporting, local searches, access to concierge services, connecting to a vehicle dealer, and roadside assistance. The term “off-board” as used herein refers to a location away from and outside the vehicle. The term “local search” as used herein refers to a point-of-interest (POI) search based on proximity to a specific location. The examples given above are regarded as being vehicle-centric in nature and many invoke some form of vocal communication with a live agent or an off-board interactive automation system.

The present invention provides novel and efficient systems and methods for protecting assets from harm and for reducing insurance risk. Exemplary embodiments of the invention provide a telematics vehicle location system capable of capturing a detailed set of location metrics for subscribed vehicles, a weather identification system operable to define dynamically a warning area in which dangerous weather is present and/or predict where that dangerous weather will be at a future time, and a data processing system operable to process the defined warning area, to identify a subset of the subscribed vehicles in the defined warning area, and to communicate with each of the owners of the subscribed vehicle subset warning messages and safety directions. A “subscriber vehicle” 102 as used herein refers to a vehicle 102 tied to a subscription plan with a telematics service provider, for example, that is able to, through the systems and methods of the present invention, provide a warning message to at least one predetermined contact person associated with the subscriber vehicle 102, and, thus, the subscription plan.

Exemplary embodiments of the invention provide measures for reducing insurance risk by dynamically supplying warning information to insureds, which result in removal of the risk of the insured asset or increase in the protection of the asset.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

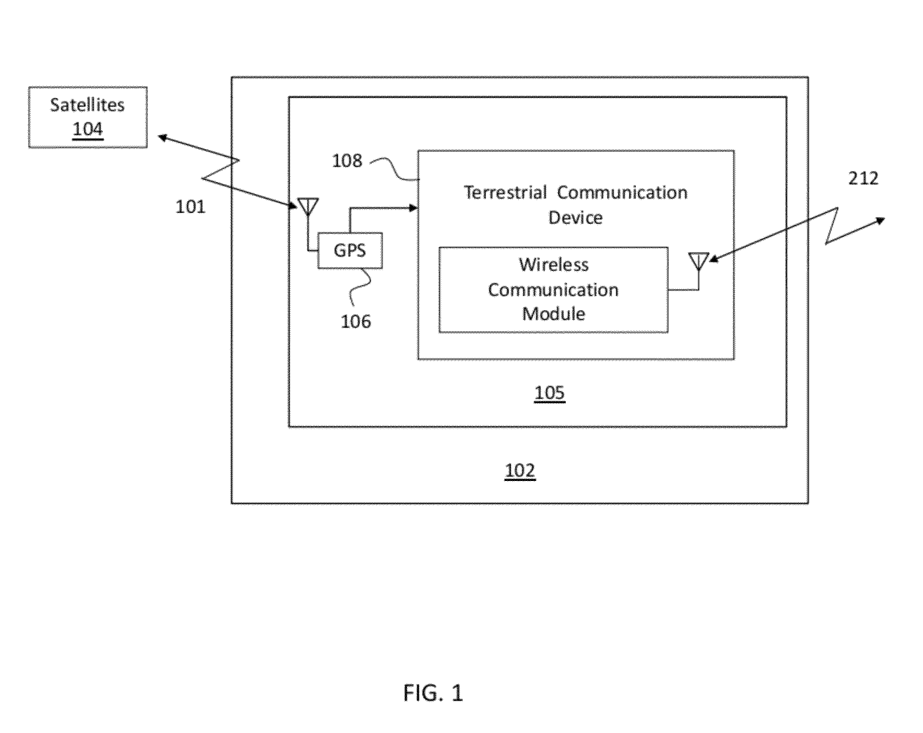

Described now are exemplary embodiments of the present invention. Referring now to the figures of the drawings in detail and first, particularly to FIG. 1, there is shown an exemplary embodiment of a vehicle telematics communications infrastructure utilized with systems and methods of the present invention. FIG. 1 shows several advantageous features of the present invention, but, as will be described below, the invention can be provided in several combinations of features and components, and varying numbers and functions of the components. FIG. 1 depicts an exemplary embodiment of the present invention where an asset or vehicle 102, e.g., an automobile, receives GPS signals through a wireless communication link 101 established with a plurality of satellites 104. The vehicle 102 is equipped with a telematics system 105 including a GPS navigation receiver 106 and a terrestrial communication device 108 including a wireless communication module, e.g., devices operable on GSM (Global System for Mobile Communications), CDMA (Code Division Multiple Access), one of the cellular wireless standards, i.e., 2G, 3G, or 4G, an SMS sender, and others. Through its use of GPS technology, the present invention is able to precisely monitor the location, movement, status, and behavior of the vehicle 102 and to communicate this data outside the vehicle 102. The GPS navigation system receiver 106 and the terrestrial communication device 108 are typically devices housed within the vehicle 102 and not obviously visible to a driver.

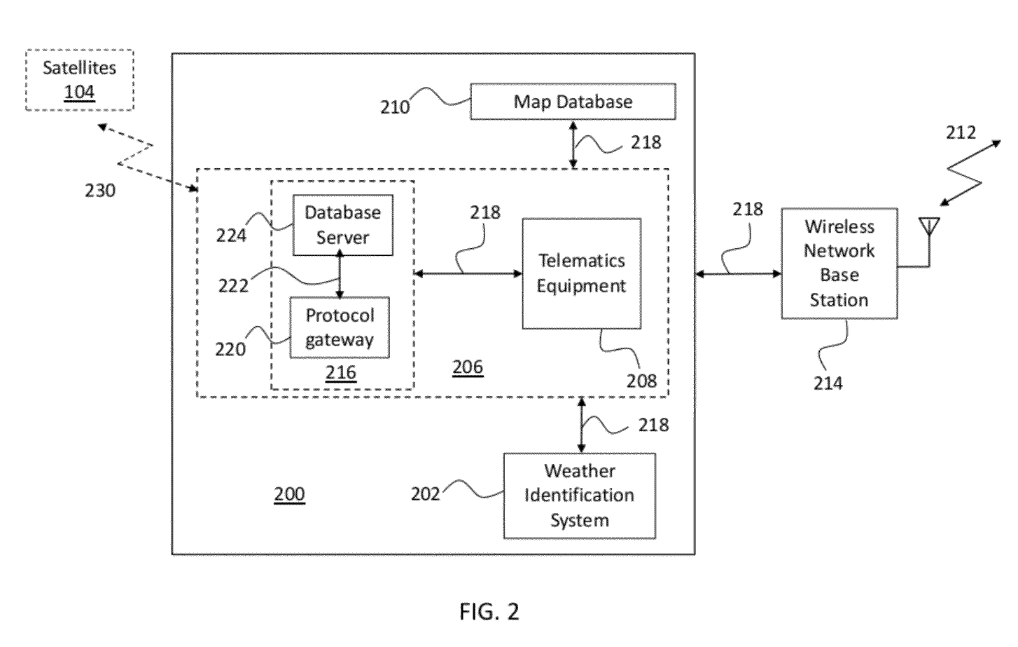

As provided in FIGS. 1 and 2, the vehicle telematics system 105 interfaces with an exemplary control system 200 through a wireless communication link 212 established with at least one wireless network base station 214. The control system 200 interfaces with at least one wireless network base station 214 directly and/or wirelessly through a communication link 218. As shown in FIG. 2, the exemplary control system 200 includes a data processing system 206, a weather identification system 202, and a map database 210. The data processing system 206 is in communication with each of the weather identification system 202 and the map database 210 either directly and/or wirelessly through a communication link 218. The data processing system 206 is comprised of telematics service provider equipment 208 in bidirectional communication with a data center 216 directly and/or wirelessly through a communication link 218.

According to the present exemplary embodiment, the terrestrial communication device 108 of the vehicle telematics system 105 works in conjunction with the telematics provider equipment 208 to provide an owner with telematics services such as telephone interconnect, short message service (SMS) via a short message service center (SMSC), dispatch and/or instant conferencing, circuit data, packet data, combinations thereof, as well as other data services from the provider.

As indicated by the dashed-line box enclosing the data processing system 206, the data processing system 206 may be an integrated system, wherein the service provider telematics equipment 208 and the data center 216 are located at the same location, for example, at a facility operated by the telematics service provider. Alternatively, as illustrated with the dashed-line box enclosing the data center 216, the data center 216 may be remote from the telematics equipment 208 provided by the telematics service provider. In any event, the data center 216 is remote from the vehicle 102 and may, therefore, be referred to herein as a “remote data center” 216.

The data center 216, through a protocol gateway 220, exchanges data 222 with database servers 224. The database servers 224 facilitate execution of PC or web-based software that turns the data 222 into information that is utilized by systems and methods of the invention in conjunction with computerized mapping and vehicle tracking software.

It should be noted that the invention is in no way limited to the infrastructure illustrated in FIG. 1 and described above. The present invention contemplates any known or to-be-developed communication systems and methods for obtaining information pertaining to driving metrics and conditions of a vehicle and communicating the information to a remote data center 216. As one example, indicated by the dashed-line arrow 230, the data processing system 206, for example, the remote data center 216 thereof, can communicate with one or more of the plurality of satellites 104, which, in turn, communicates with a GPS transceiver 106 of a vehicle telematics system 105.

In accordance with embodiments of the present invention, during operation of the vehicle 102, the GPS receiver 106 is in constant or regular communication with the plurality of GPS satellites 104 and communicates terrestrial positioning information pertaining to the vehicle 102 and its movements to the data center 216 of the data processing system 206. This data 222, for example, include such metrics as the present position, the present speed (if any), and the present heading or route (if one is predetermined).

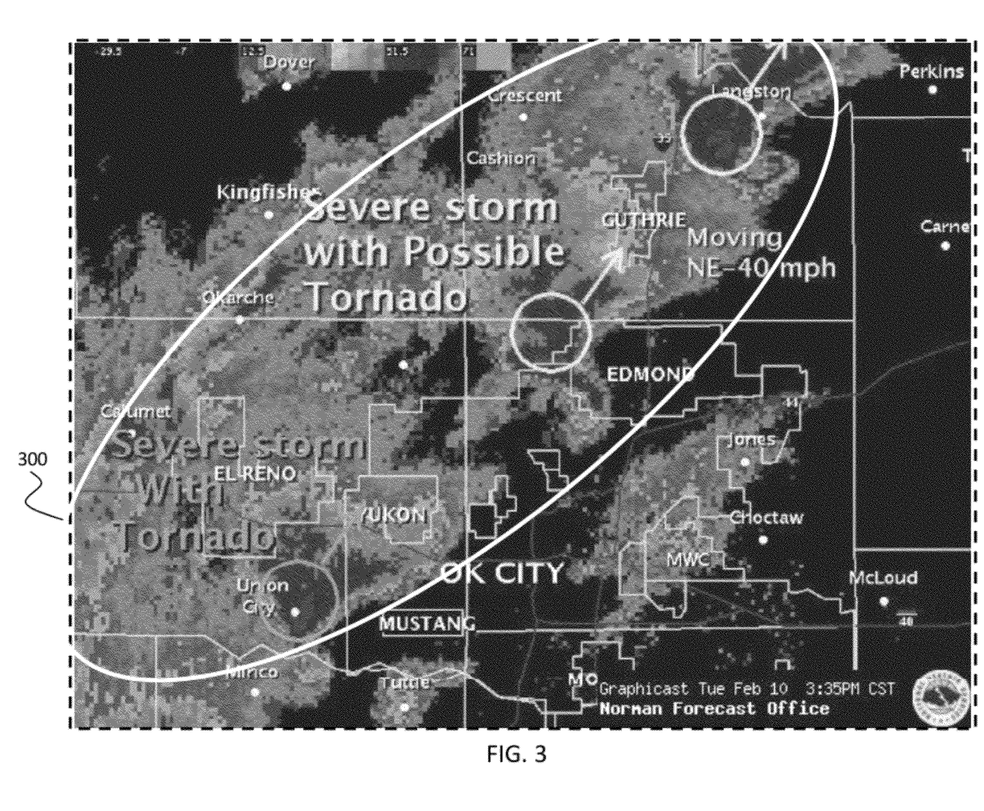

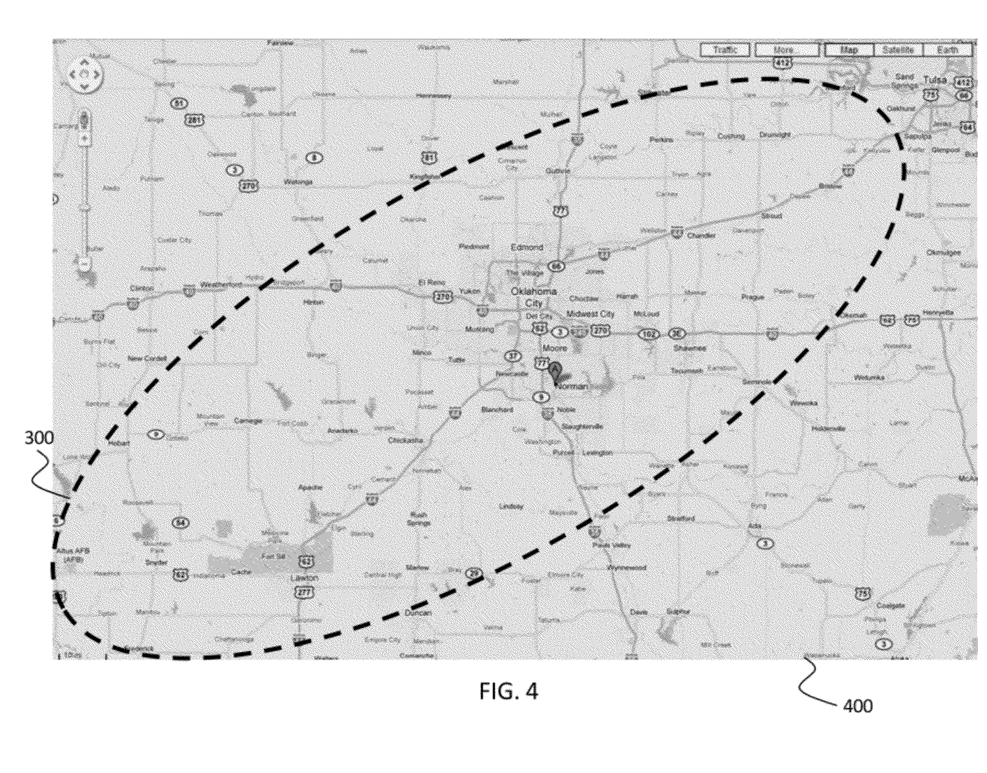

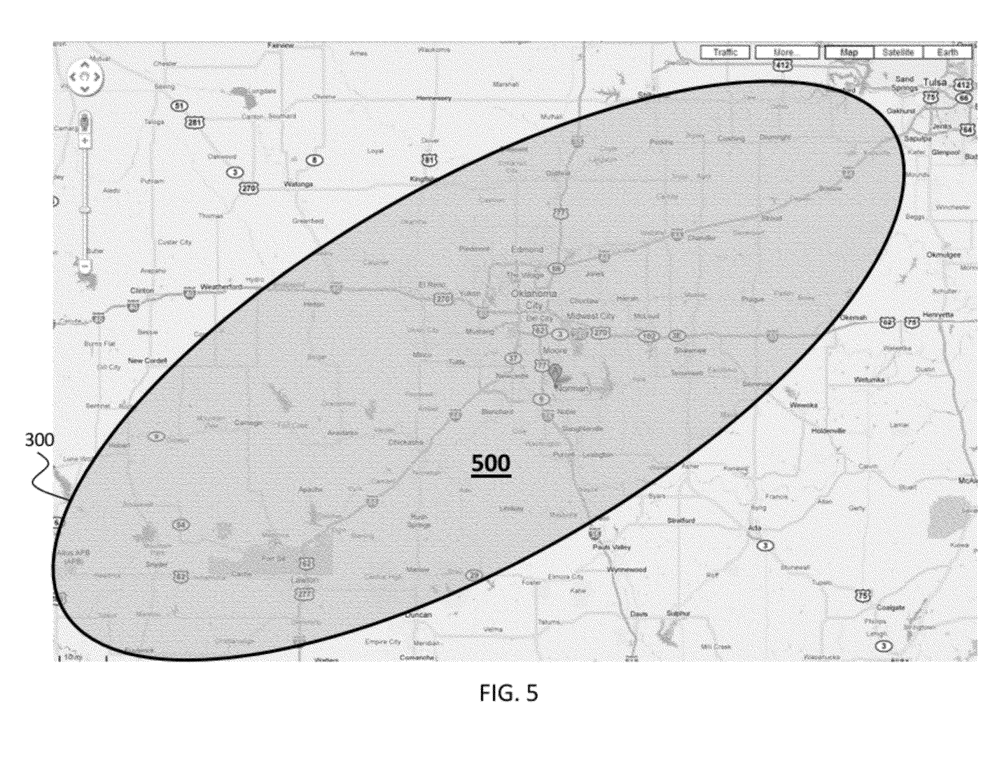

As shown in FIG. 2, any aspect of the data processing system 206, for example, the data center 216 and/or the telematics provider equipment 208, is in communication with a weather identification system 202 operable to define dynamically a geographic area 300 (shown in FIG. 3) in which dangerous weather is present and/or where that dangerous weather will be at a future time. Similarly, any aspect of the data processing system 206 (e.g., data center 216 and/or the telematics provider equipment 208) is in communication with a map database 210. Alternatively, the map database 210 may be part of the data center 216 and updated dynamically. The map database 210 has sufficient detail to allow the data center 216 to identify a street address based upon a corresponding identification of a particular GPS geographic location, for example, the current location of a vehicle 102. The data center 216 is further operable to process the received geographic area 300 in which dangerous weather is present and project that area 300 upon a portion(s) of the map 400 (shown in FIG. 4) in the map database 210 to define a warning area 500 (shown in FIG. 5).

After the warning area 500 is defined, the data center 216 can compare the present location of all subscriber vehicles 102 with the boundaries of the warning area 500 utilizing the data 222, which includes, among other information, the GPS location of every subscriber vehicle 102. The data center 216, then, determines a subset of the subscriber vehicles 102 within the warning area 500. Included with the data 222 for every subscriber vehicle 102 is contact information for each respective owner. The data center 216, then, gathers the contact information for all of the subscriber vehicles 102 inside the warning area 500 and begins a process for communicating with at least one pre-assigned contact person associated with the subscriber vehicle 102. A pre-assigned contact person may be, for example, the insured or owner of the subscriber vehicle 102 or any other driver, passenger, or individual who the insured designates as the recipient of risk or warning messages. The communication can occur across any media including in-vehicle telematics (through dashboard displays, heads-up displays, and/or audio), phone, cell phone, pager, text messaging, and email, to name a few. Thus, the contact information of the pre-assigned contact person is associated with the subscriber vehicle 102 information, e.g., make and model and VIN number, and can include landline and mobile telephone numbers (e.g., home, work, cellular, and third party emergency contact numbers), pager numbers, home or work address, and email addresses.

In accordance with an embodiment of the present invention, the data processing system 206, for example, through the data center 216, determines whether the subject vehicle 102 is currently mobile. If it is determined that the vehicle is on the move, the communication will first be broadcast via the end-vehicle telematics to the vehicle driver at that time. The driver is then provided with the ability to indicate whether they have the authority and/or if they are willing to ensure the vehicle's safety by, for instance, driving to a safe location or stowing the car in a covered structure. If the response is negative, the system will continue trying contact points to reach the owner.

The data center 216 communicates with the various stored contact points for each pre-assigned contact person and records when a successful communication occurs, for example, by receiving a responsive communication indicating that the safety warning was received and that the pre-assigned contact person is taking precautionary measures to assure the safety of the asset. If no successful communication occurs, a fault can be recorded and, if desired, live communication can be scheduled or the communication can end. This process is repeated for every owner identified as having an asset 102 in the warning area 500.

As the data center 216 is already set up for communicating point-of-interest locations and turn-by-turn directions, for example, as described in U.S. Pat. No. 7,373,248, co-pending U.S. application Ser. No. 12/541,496, and U.S. Provisional Application Nos. 61/497,849 and 61/497,768, each of which is incorporated herein by reference in their entireties, each owner is provided with the option of receiving assistance in locating a safe destination for the vehicle 102. For example, if a vehicle 102 is at an open parking lot and a hail storm is approaching, the owner can prompt the system for assistance in obtaining an address or turn-by-turn directions to a covered parking lot or other pre-defined safe location. As an alternative, if a vehicle driver simply wants to drive away from the danger, the data center 216, knowing where the warning area 500 is and where it is heading, can give the driver a direction and route to a safer location than present.

The invention's ability to send messages directly to the vehicle 102 to avoid being in the “line of fire” for an event that has a high likelihood to cause severe damage is significant to insurers who cover assets 102 registered and protected by the invention.

In addition, exemplary embodiments of the invention provide systems and methods for reducing insurance risk by dynamically supplying warning information to insureds that enable the insureds to find safety for insured assets at risk.

In another exemplary embodiment, an insured provides a list of “frequent” locations, for example two or three locations, such as a home location, work location, boat slip, mobile home storage lot, or the like for incorporation into a warning service subscription plan with the telematics service provider. When an inclement weather circumstance is predicted, the telematics service provider, utilizing the system in accordance with the present invention, polls the frequent locations to determine whether a subscriber vehicle 102 is present within the polled geographic area and send the appropriate warning message to the pre-assigned contact persons. In addition, the vehicle telematics systems 105 can be used to identify new frequent locations, based upon prior stored location data, and these new frequent locations can be polled as well.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for warning at least one pre-assigned contact person associated with a vehicle that the vehicle is within a geographical warning zone, the method comprising:
initiating and establishing a wireless communication link between a vehicle telematics system of the vehicle and a control system remote from the vehicle, the control system including:
a weather identification system;
a map database; and
a data processing system operable to communicate with the weather identification system and the map database though at least one communication link;
detecting a dangerous weather condition;
identifying a geographic area within which the dangerous weather condition is detected;
communicating the geographic area to the data processing system;
interfacing the geographic area with the map database to define a geographic warning zone;
locating the vehicle within the geographic warning zone; and
communicating a warning message to the at least one pre-assigned contact person associated with the vehicle regarding the vehicle being located within the geographic warning zone.

2. The method according to claim 1, wherein the data processing system includes:
telematics equipment operable to provide the vehicle telematics system with telematics services; and
a data center including at least one database server and at least one protocol gateway operable to exchange data with the at least one database server.

3. The method according to claim 2, wherein the data center is at least one of:
remote from the telematics equipment and communicatively connected thereto through a wireless communication link; and
co-located with the telematics equipment and communicatively connected thereto.

4. The method according to claim 2, wherein the located vehicle is a subscriber vehicle associated with a subscription plan provided by a telematics service provider.

5. The method according to claim 2, which further comprises carrying out the locating step by:
receiving location information from the vehicle telematics system of the vehicle; and
comparing the received location information with the geographic warning zone to determine a subset of vehicles located within the geographic warning zone.

6. The method according to claim 1, which further comprises, for the at least one pre-assigned contact person associated with the vehicle, gathering contact information including at least one of:
a telephone number;
an email address; and
a pager number.

7. The method according to claim 6, which further comprises carrying out the step of communicating a warning message utilizing the gathered contact information.

8. The method according to claim 1, which further comprises carrying out the step of communicating the warning message by:
providing at least one of an audible message and a video display message through the vehicle telematics system;
calling a telephone including at least one of a landline telephone and a mobile device;
sending a text message;
paging a device; and
sending an email.

9. The method according to claim 1, which further comprises at least one of:
receiving a responsive communication from the at least one pre-assigned contact person regarding receipt of the warning message and recording the communication attempt as successful; and
receiving no responsive communication from the at least one pre-assigned contact person and recording the communication attempt as unsuccessful.

10. The method according to claim 9, which further comprises, if the communication attempt is successful and if the at least one pre-assigned contact person is located inside the located vehicle, providing direction information of a safe location to the at least one pre-assigned contact person,
wherein the safe location is at least one of:
a pre-defined safe location within the geographic warning zone; and
a location outside the geographic warning zone.

11. The method according to claim 1, wherein the at least one communication link is at least one of a direct communication link and a wireless communication link.

12. A system for warning at least one pre-assigned contact person associated with a vehicle that the vehicle is within a geographical warning zone, the system comprising:
a control system remote from the vehicle and communicatively connected to a vehicle telematics system of the vehicle, the control system including:
a data processing system;
a weather identification system operable to:
detect a dangerous weather condition;
identify a geographic area within which the dangerous weather condition is detected; and
communicate the geographic area to the data processing system; and
a map database,
the data processing system operable to:
receive and process data from the vehicle telematics system; and
communicate with the weather identification system and the map database though at least one communication link;
the control system further operable to:
interface with the map database to define a geographic warning zone based upon the geographic area communicated from the weather identification system;
locate a vehicle within the geographic warning zone; and
communicate a warning message to the at least one pre-assigned contact person associated with the vehicle regarding the vehicle being located within the geographic warning zone.

13. The system according to claim 12, wherein the data processing system includes:
telematics equipment operable to provide the vehicle telematics system with telematics services; and
a data center including at least one database server and at least one protocol gateway operable to exchange data with the at least one database server.

14. The system according to claim 12, wherein the data center is at least one of:
remote from the telematics equipment and communicatively connected thereto through a wireless communication link; and
co-located with the telematics equipment and communicatively connected thereto.

15. The system according to claim 12, wherein the located vehicle is a subscriber vehicle associated with a subscription plan provided by a telematics service provider.

16. The system according to claim 15, wherein the at least one database server is operable to store information associated with the subscriber vehicle, the information including contact information for the at least one pre-assigned contact person associated with the subscriber vehicle including at least one of:
a telephone number;
a email address; and
a pager number.

17. The system according to claim 12, wherein the control system is operable to communicate the warning message to the at least one pre-assigned contact person through at least one of:
the vehicle telematics system including at least one of a visible display message and an audible message;
a telephone call to at least one of a landline telephone and a mobile device;
a text message;
a page to a device; and
an email.

18. The system according to claim 12, wherein the control system is further operable to send information to the at least one pre-assigned contact person indicating a safe location,
wherein the safe location is at least one of:
a pre-defined safe location within the geographic warning zone; and
a location outside the geographic warning zone.

19. The system according to claim 15, wherein the vehicle telematics system interfaces with the telematics service provider through a wireless communication link established with at least one wireless network base station.

20. The method according to claim 12, wherein the at least one communication link is at least one of a direct communication link and a wireless communication link.
